(19) United States
(12) Patent Application Publication
(10) Pub. No.: US 2004/0086350 A1
(43) Pub. Date: May 6, 2004

(54) Five-simultaneously-working-axis computerized numerical controlled tooth cutting machine tool for plane enveloping toroidal worms

(76) Inventors: Yaxiong Zhang, Tianjin (CN); Lin Qi, Tianjin (CN)

Correspondence Address: MILDE, HOFFBERG & MACKLIN, LLP, SUITE 460, 10 BANK STREET, WHITE PLAINS, NY, 10606, US

(21) Appl. No.: 10/331,450

(22) Filed: Dec. 27, 2002

(30) Foreign Application Priority Data
Oct. 31, 2002 (CN) 02282433.2

(51) Int. Cl. B23F 13/00

(52) U.S. Cl. 409/2

(57) ABSTRACT

The present invention provides a five-simultaneously-working-axis computerized numerical control tooth cutting machine tool for toroidal worms, including: a body of the machine tool and a controlling cabinet, the body includes: a bed, a spindle box with a spindle, a longitudinal sliding table, a traverse slider, a vertical guideway mounted on the slider, and a tailstock, a cutter rest that supports a rotating cutter head is mounted on the vertical guideway, the spindle rotates about A-axis thereof, the table longitudinally slides relative to the bed along Y-axis, the cutter head rotates about B-axis thereof and traversely shifts along X-axis, as well as the cutter head makes up/down shift along Z-axis of the guideway vertically, the control cabinet is equipped with programs for controlling spindle rotation and the programs for controlling the shitting along longitudinal, traverse and vertical directions as well as the rotation of cutter head so as to make the movements about or along the five axis of A, Y, X, Z and B simultaneously work together to control the shitting of cutting edge of the cutter on the cutter head relative to the workpiece and simulate an inclined plane in spatial locations in order to envelop out the tooth flank of plane enveloping toroidal worms. The effect of this invention shows that the rotating speed of cutter shaft and workpiece shaft can make the cutting velocity up to 200 m/min, and the working efficiency is six to seven times higher than that of worm grinding, the productivity can be improved greatly.

### FIELD OF THE INVENTION

The present invention relates to five-simultaneously-working-axis Computerized Numerical Control (CNC) tooth-cutting machine tools for plane enveloping toroidal worms.

### BACKGROUND OF THE INVENTION

Some existing toroidal worm grinding equipment have been developed recently, such as German HNC 35 TP and the Chinese Patent No. ZL92204765.0 patent entitled “Four-simultaneously-working-axis computerized numerical control toroidal warm grinding machines”. These equipment have such advantages that the thread of plane enveloping toroidal worms can accurately be formed in once grinding; the ground work-pieces can acquire high accuracy and perfect surface roughness. However, their deficiencies are low productiveness and expensive cost of the machined, so that it results in very high cost of the machined work-pieces and cannot meet the needs of constantly developing production.

The technical problem to be solved by this invention is to provide a five-simultaneously-working-axis CNC tooth-cutting machine tools for accurately forming plane enveloping toroidal worming in order to improve the productivity and reduce the cost.

In order to solve the above technical problem the technical scheme adopted by this invention is to provide a five-simultaneously-working-axis computerized numerical control tooth cutting machine tool for toroidal worms, including: a body of the machine tool and a controlling cabinet, the body includes: a bed, a spindle box with a spindle, a longitudinal sliding table, a traverse slider, a vertical guideway mounted on the slider, and a tailstock, a cutter rest that supports a rotating cutter head is mounted on the vertical guideway, the spindle rotates about A-axis thereof, the table longitudinally slides along Y-axis relative to the bed, the cutter head rotates about B-axis thereof and traversely shifts along X-axis, as well as the cutter head makes up/down shift along Z-axis of the guideway vertically, the control cabinet is equipped with programs for controlling the five axis of A, Y, X, Z and B simultaneously work together, wherein a first coordinate system Σ₁ is connected with the workpiece, a second coordinate system Σ₂ is connected with an imaginary gear, a third coordinate system Σ₃ is connected with the rotating cutter head and a fourth coordinate system Σ₄ is connected with the cutting edges, based upon the transformation of coordinate systems, the motion equations of five axes of A-, B-, Y-, X-, and Z-axes of the machine tool can be determined such that the shitting of cutting edge of the cutter on the cutter head is controlled to simulate an inclined plane in spatial locations in order to envelop out the tooth flank of plane enveloping toroidal worms.

Perfectly, the inclined plane simulated by the cutting edge of the cutters rotates around central axis of the imaginary gear K₂ (o₂), i.e. the composition of both the rotation of B-axis and the revolution of B-axis around the axis of K₂ (o₂), at the same time workpiece rotates around K₁ (o₁) (i.e. A-axis), in the course of relative motions the tooth flank of plane enveloping toroidal worm is generated.

Perfectly, the thread forming motion of plane enveloping toroidal worm can correctly be controlled by means of the control of the values of a rotating angle per unit time of the workpiece φ₁, a rotating angle per unit time of the imaginary gear φ₂, a rotating angle per unit time of the cutter head φ₃, an angle τ of the center o₃ of the cutter head rotating around the center o₂ of the imaginary gear and a distance h of the center o₂ of the imaginary gear making straight-line shift along the central axis thereof k₂(o₂), in which φ₁/φ₂ is equal to the gear ratio.

Perfectly, there are at least two blades mounted on the rotating cutter head, the cutting edge of the blade is straight line which lies on the plane perpendicular to the axis of the rotating cutter body.

Perfectly, the center o₃ of the rotating cutter head and the cutting edges are all located on two tooth planes of the imaginary gear; while two tooth planes are inclined with angle β and tangential to two imaginary spatial cones respectively, the half conic angles of two cones is equal to the inclined angle β, the diameter r_{b} of an imaginary cones is equal to the diameter r_{bt} of main basic circle of the imaginary gear, the cutting edges on the cutter head shift along the tooth plane of the imaginary gear; while the inclined plane is tangential to the spatial cone and rotates around the central axis k₂ (o₂) of the cone; the center o₂ of the imaginary gear makes up/down shifts along the vertical axis k₂ (φ₂), the cutting edge comes into cutting at point N and secedes from cutting at point S, the coordinates of every point on the workpiece makes following up motions along X-, Y- and Z-axes while makes the circular interpolating motion about B-axis.

Perfectly, there are at least two blades mounted on the rotating cutter head, the cutting edge of the blade is straight line which lies on the plane perpendicular to the axis of the rotating cutter body.

Perfectly, the spindle box and tailstock are mounted on the bed, the longitudinal sliding table is movable mounted on bed and the traverse slider is mounted on the sliding table.

Perfectly, the longitudinal sliding table is movable mounted on bed, and the spindle and tailstock are fixed on sliding table, the traverse slider is mounted on bed.

The effect of the machine tool is that the rotating speed of cutter shaft and workpiece shaft can make the cutting velocity up to 200 m/min, thus the working efficiency is six to seven times higher than that of worm grinding and the productivity can be improved greatly. The machine tool of the invention is to supplement the deficiency of toroidal worm grinding machines and to provide a sort of high-productivity tooth cutting machine tools.

### BRIEF DESCRIPTION OF THE ATTACHED DRAWINGS

FIG. 1 is the schematic view showing the first embodiment of five-simultaneously-working-axis CNC tooth-cutting machine tools for plane enveloping toroidal worms in accordance with the invention.

FIG. 2 shows the top view of FIG. 1.

FIG. 3 is the side elevation of FIG. 1.

FIG. 4 is the schematic view showing the second embodiment of five-simultaneously-working-axis CNC controlled tooth-cutting machine tools for plane enveloping toroidal worms.

FIG. 5 is the top view of FIG. 4.

FIG. 6 is the side elevation of FIG. 4.

FIG. 7 (1) is the schematic view for forming principle of plane enveloping toroidal worms according to the invention;

FIG. 7 (2) shows the coordinate system for forming principle of plane enveloping toroidal worms according to the invention;

FIG. 8 (1) shows the motion state of cutter when h=0;

FIG. 8 (2) shows the motion state of cutter when h<0;

FIG. 8 (3) shows the motion state of cutter when h>0;

FIG. 9 shows the motion state of the cutter head in i2 (o2) o2 j2 (o2).

### DETAILED DESCRIPTION OF THE PREFERRED EMBODIMENTS

By referring to the attached drawings and embodiments, the technical scheme of the invention would further be expounded as follows.

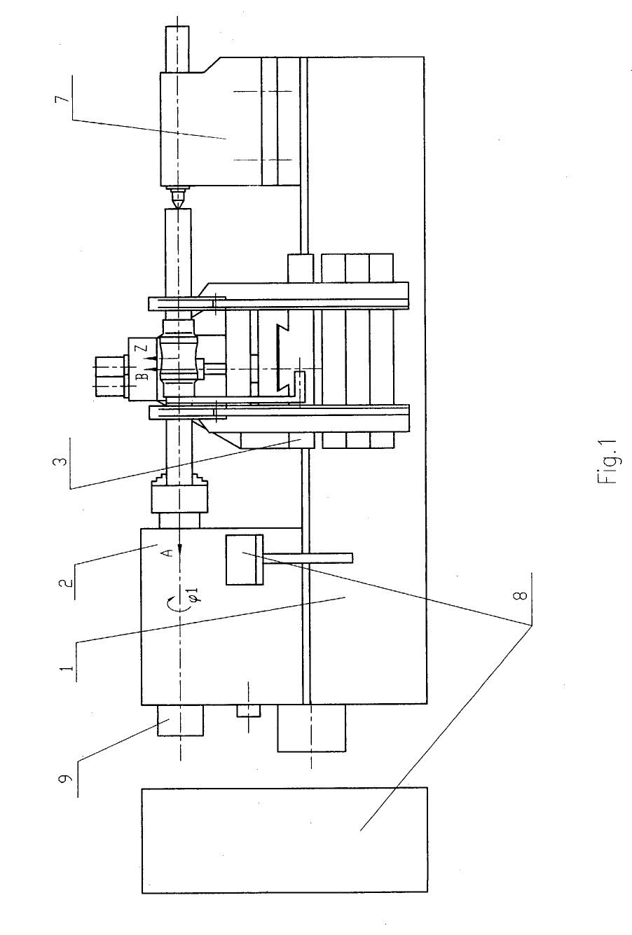

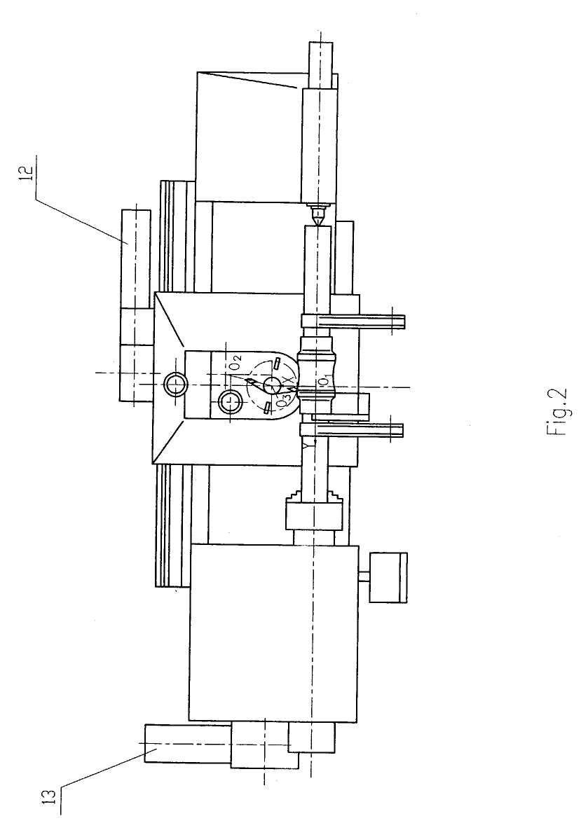

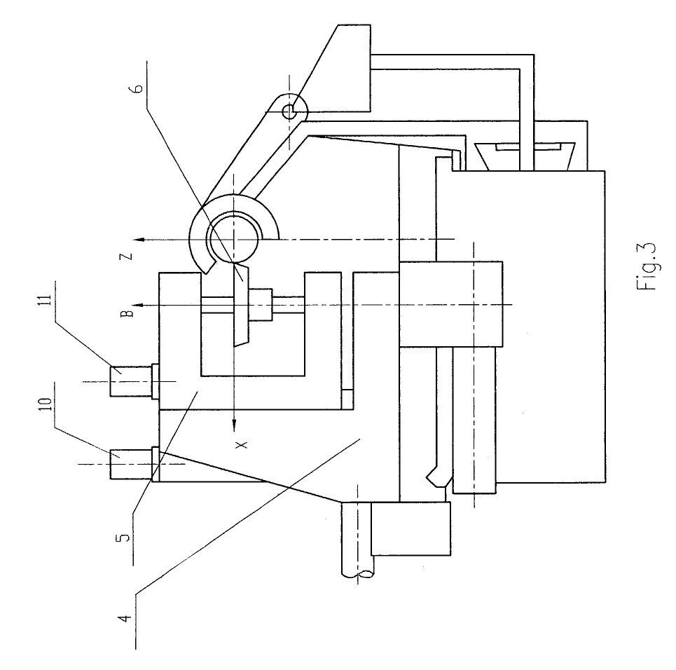

As shown in FIGS. 1, 2 and 3, the first embodiment of five-simultaneously-working-axis CNC tooth-cutting machine tools for lane ₃enveloping toroidal worms in accordance with the invention consists of two parts of a body of machine tool and a controlling cabinet. The body of the machine tool mainly includes bed 1, spindle box 2, longitudinal sliding table 3, vertical guideway, traverse slider 4 and tailstock 7. The spindle box 2 and tailstock 7 are mounted on the bed 1. The workpiece is mounted between spindle of the spindle box and tailstock 7. The longitudinal sliding table 3 is movable mounted on bed 1. The traverse slider 4 is mounted on the slide table. The vertical guideway is mounted on the traverse slider 4. A cutter rest 5 is mounted along the vertical guideway for supporting a rotating cutter head 6. The rotating cutter head 6 is mounted on the cutter rest 5 and can rotate about B-axis by the driving of servomotor 11. At least two blades are mounted on the rotating cutter head 6. The cutting edge of the blades is a straight line, which lies on the plane perpendicular to the axis of the rotating cutter head. The adjustment structure of cutter rest 5 includes servomotor 10 and a lead screw-nut-mechanism. The rotating cutter head 6 is mounted on the cutter rest 5 located on the vertical guideway and can make an up/down shift movement along Z-axis by the driving of servomotor 10. The revolution speed of A-axis can automatically be adjusted according to the given cutting velocity and the size of workpiece to keep the constant cutting velocity.

The main movements of the machine tool include: the rotating movement of the spindle about A-axis thereof; the longitudinal sliding movement of the table 3 relative to the bed 1 along Y-axis; the rotating movement of the cutter head 6 about B-axis thereof; the traverse shifting movement of the cutter head 6 along X-axis; and up/down shifting movement of the cutter head 6 along Z—axis of the guideway vertically. Thus the workpiece rotates about A-axis, and the cutter head 6 rotates about B-axis with a given speed, traverse shifts along X-axis and up/down shifts along Z-axis as well as longitudinal shifts relative to the workpiece mounted between spindle of the spindle box and tailstock 7 along Y-axis.

The control cabinet is equipped with the programs for controlling spindle rotation and the programs for controlling the shitting along longitudinal, traverse and vertical directions as well as the rotation of cutter head so as to make the movements about or along the five axis of A, Y, X, Z and B simultaneously work together to control the shitting of cutting edge of the cutter on the cutter head 6 relative to the workpiece to simulate an inclined plane in spatial locations in order to envelop out the tooth flank of plane enveloping toroidal worms. Therefore the thread of plane enveloping toroidal worms would be formed. The speed of spindle can automatically be adjusted according to the given cutting velocity and the size of workpiece to keep the constant cutting velocity.

In order to improve the productivity of tooth cutting, a vertical guideway is mounted on the slider 4. The cutter body is connected with the nut through the structure of ball lead screw. The cutting edge of the cutter makes up/down shift along the guideway. The cutting edge of the blade is straight line which lies on the plane perpendicular to the axis of the rotating cutter head. The left cutting edge is tangential to an imaginary special circular cone, while the right cutting edge to another imaginary circular cone. The bases of these two cones are congruent with one another, while the vertexes of two cones are located in opposite positions. Five-axis-simultaneously-working makes the cutting edges of the cutter shift along an inclined plane and generates the thread of worm.

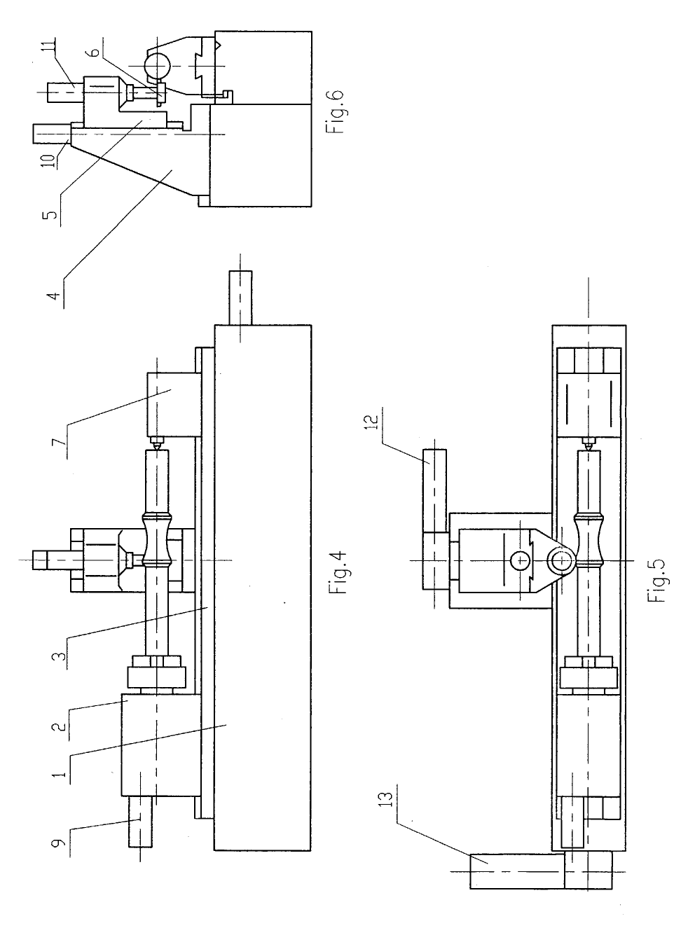

As shown in FIGS. 4, 5 and 6, the second embodiment of five-simultaneously-working-axis CNC tooth-cutting machine tools for plane enveloping toroidal worms in accordance with the invention will be described as follows, in which the same reference number indicates same member as the first embodiment and the description for same structure as the first embodiment will not be described herein.

The longitudinal sliding table 3 is mounted on bed 1. Spindle 2 and tailstock 7 are fixed on sliding table 3. The workpiece is mounted between spindle A and tailstock 7. The spindle controls the rotation of the workpiece by using servomotor 9. The longitudinal sliding table 3 makes the workpiece shift along Y-axis through servomotor 13. The traverse slider 4 is mounted on bed 1 and can feed along X-axis driven by servomotor 12. The rotating cutter 6 is mounted on the cutter rest 5 located on the vertical guideway and can rotate around B-axis driven by servomotor 11. The cutter rest is driven by servomotor 10 through lead screw nut mechanism and makes the cutter head up/down shift along Z-axis. The revolution speed of A-axis can automatically be adjusted according to the given cutting velocity and the size of workpiece to keep the constant cutting velocity. Thus the workpiece both rotates about A-axis and shifts along Y-axis, and the cutter head 6 rotates about B-axis with a given speed, traversely shifts along X-axis and up/down shifts along Z-axis.

Similarly, the programs equipped within the control cabinet controls spindle rotation and the shitting movements along longitudinal, traverse and vertical directions as well as the rotation of cutter head so as to make the movements about or along the five axis of A, Y, X, Z and B simultaneously work together to control the shitting of cutting edge of the cutter on the cutter head 6 relative to the workpiece to simulate an inclined plane in spatial locations in order to envelop out the tooth flank of plane enveloping toroidal worms. Therefore the thread of plane enveloping toroidal worms would be formed.

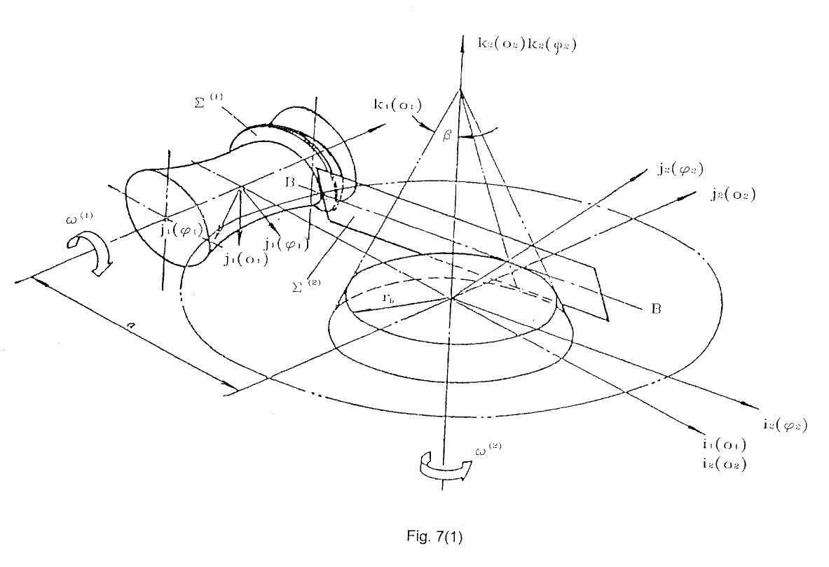

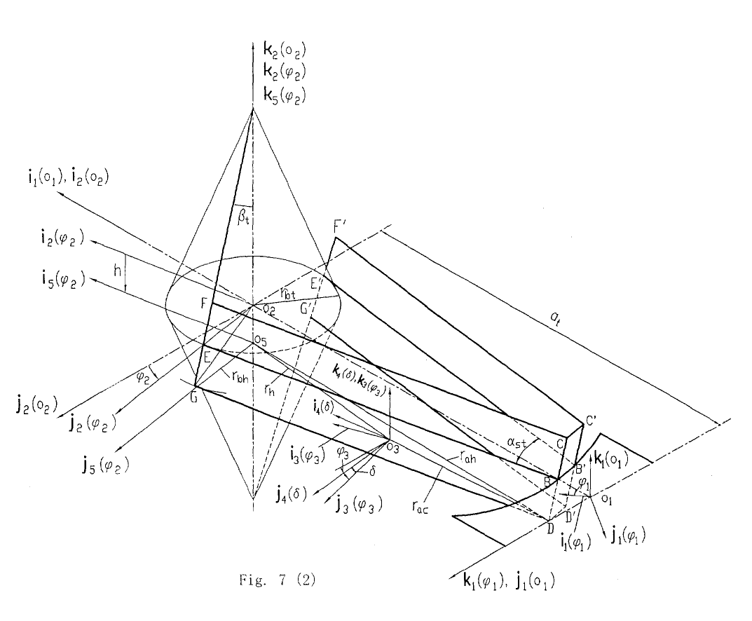

As shown in FIG. 7(1), under the generating motion of five-axis-simultaneously-working the cutting edge of the cutter would simulate a plane, while the plane rotates around K₂ (o₂) (i.e. the composition of both the rotation of B-axis and the revolution of B-axis around K₂ (o₂)), at the same time toroidal worm (i.e. workpiece) rotates around K₁ (o₁) (i.e. A-axis). In the course of relative motion the tooth flank of plane enveloping toroidal worm would be generated.

As shown in FIG. 7(2), a first coordinate system Σ₁: {o₁; i₁(o₁), j₁(o₁), k₁(o₁)} is connected with the workpiece of worm, B B′ is the tip circle of the worm. A second coordinate system Σ₂:{o₂; i₂(o₂), j₂(o₂), k₂(o₂)} is connected with the spatial imaginary gear. A third coordinate system Σ₃:{o₃(φ₃), j₃(φ₃), k₃(φ₃)} is connected with the cutter head. The center o₃ of the cutter head rotates around the spatial imaginary gear o₂. A fourth coordinate system Σ₄:{i₄(δ), j₄(δ), k₄(δ)} is connected with the cutting edges. Assumed that quadrilateral CDFG and quadrilateral C′D′F′G′ are plane and express the tooth flank of the imaginary gear. Let the plane mesh with the thread of worm, it realizes the enveloping motion of the plane enveloping toroidal worm. This invention designs the cutting edge of rotating cutter head that lies on the tooth flank of the imaginary gear. Let the cutting edge shifts on the plane. While two planes are tangential to two imaginary cones whose bases are congruent with one another and the vertexes of two cones are located in opposite positions. The half conic angle of the plane is βₜ. The shift of cutting edge may envelop out the thread of plane enveloping toroidal worm.

As shown in FIG. 7(2), the meaning of five axes is expounded as follows.

1. A-axis: workpiece axis j₁ (φ₁), φ₁ is the rotating angle per unit time of workpiece, A-axis is the master control axis.

2. B-axis: the rotating axis of the cutter head, i.e. k₃ (φ₃) in the FIG. 7(2), φ₃ is the rotating angle per unit time of the cutter head.

3. X-axis: i.e. i₁ (o₁)-axis in the FIG. 7(2), the traverse slider makes straight-line motion along x-direction.

4. Y-axis: i.e. j₁ (o₁)-axis in the FIG. 7(2), the longitudinal sliding table makes straight-line motion along Y-direction.

5. Z-axis: i.e. k₁ (o₁)-axis in the FIG. 7(2), the machine tool makes up/down shift along Z-axis.

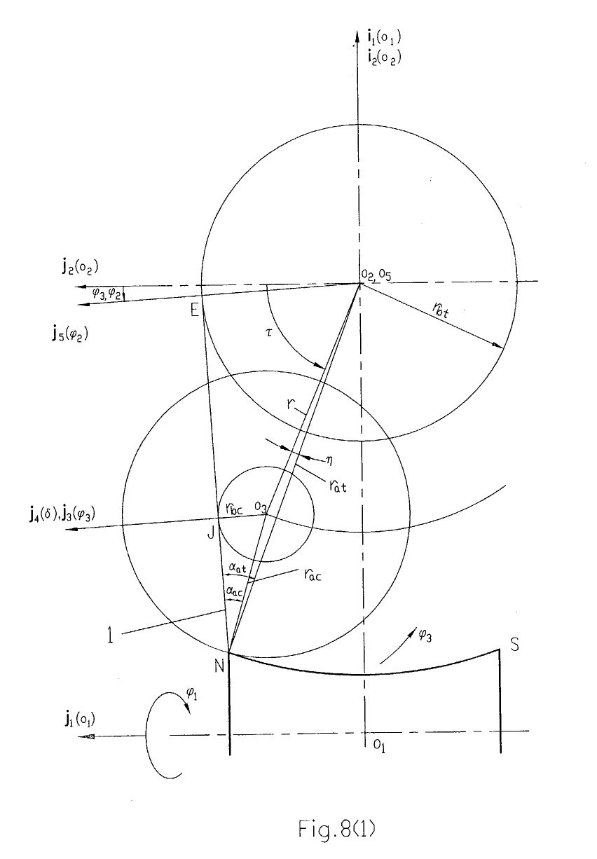

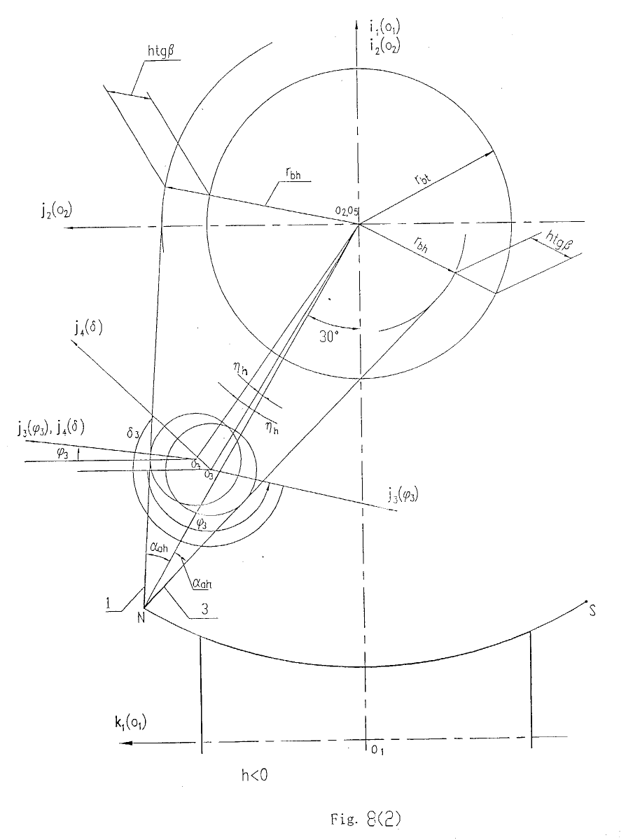

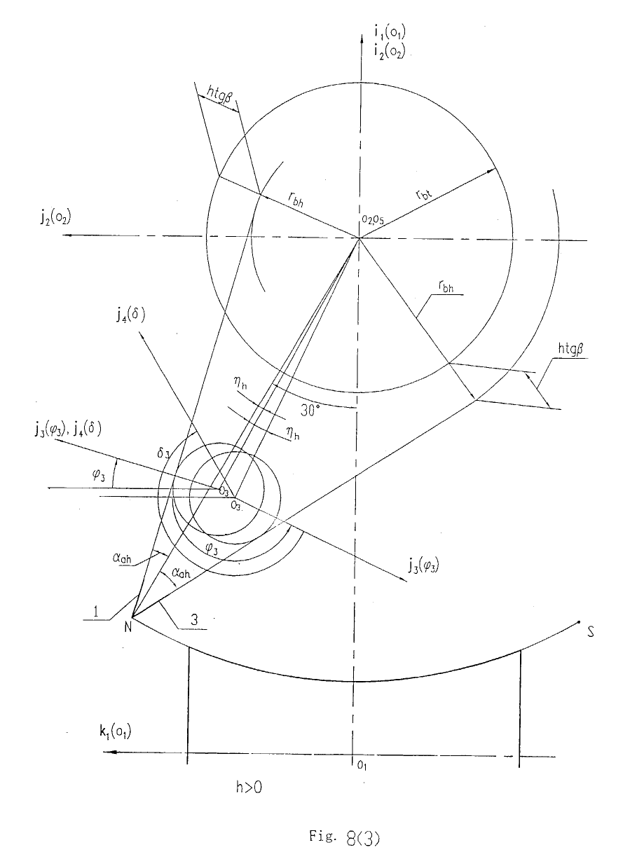

FIG. 8(1) shows that the first coordinate system Σ₁:{o₁; i₁(o₁), j₁(o₁), k₁(o₁)} represents the workpiece; while the second coordinate system Σ:{o₂; i₂(o₂), j₂(o₂), k₂(o₂) } is connected with the imaginary tool gear. When h=0, the radius of main basic circle of the imaginary gear is r_{bt}; if h≠0, the coordinate of the center o₂ of the imaginary gear will make straight-line shift along k₂(o₂)-axis, at this moment rₐₜ is the radius of the outer circle of the imaginary gear; r_{ac} is the radius of the tip circle of the cutter head. The digit 1 in the FIG. 8(1) represents the cutting edge 1. \overline{o₂o}₅=h, the value of h can be positive (refer to FIG. 8(3)), negative (refer to FIG. 8(2)) or zero.

The origin of the third coordinate system Σ₃ that is fixed with the cutter head is o₃. The origin o₃ will rotates around the center o₂ of the imaginary gear in the course of machining. The distance \overline{o₂o₃} between two origins is represented by r. The angle included between radius vector r and j₂(o₂)-axis is expressed by τ. Make the second coordinate system Σ₂:{o₂; i₂(o₂), j₂(o₂), k₂(o₂)} representing the imaginary gear be directly related to the third coordinate system Σ₃:{o₃; i₃(φ₃), j₃((φ₃), k₃(φ₃)} for the cutter head by using radius vector r and polar angle τ in order conveniently to reveal the motion relationship between the rotating center o₃ of the cutter head and the center o₂ of the imaginary gear. The shifting of the center o₃ of the cutter head can be described in the first coordinate system Σ₁:{o₁; i₁(o₁), j₁(o₁), k₁(o₁)}:

$$\begin{matrix}\begin{matrix}{x}_{1} ( {o}_{1} ) = {a}_{t} - r sin τ \\ {y}_{1} ( {o}_{1} ) = r cos τ \\ {z}_{1} ( {o}_{1} ) = h\end{matrix} ] & ( 1 ) \\ r = \sqrt{{r}_{at}^{2} - {r}_{ac}^{2} - 2 {r}_{at} {r}_{ac} cos ( {α}_{at} - {α}_{ac} )} & ( 2 )\end{matrix}$$

τ=φ₃+90°−αₐₜ−η(3)

$$\begin{matrix}{α}_{at} = {sin}^{- 1} ( \frac{{r}_{bt}}{{r}_{at}} ) & ( 4 ) \\ {α}_{ac} = {sin}^{- 1} ( \frac{{r}_{bc}}{{r}_{ac}} ) & ( 5 ) \\ η = {sin}^{- 1} ( \frac{sin ( {α}_{at} - {α}_{ac} ) \times {r}_{ac}}{r} ) & ( 6 )\end{matrix}$$

Where, αₐₜ—the pressure angle of the tip circle of the imaginary gear;

α_{ac}—the pressure angle of the tip circle of the cutter head.

Point N in the figure is the cutting-in point; point S is the seceding point.

Through ΔO₂NO₅ we can investigate the values of r and τ mentioned above.

Equations (1), (2) and (3) determine the coordinates of the center o₃ of the cutter head and the imaginary gear in the course of simultaneous working. And it is not hard to find φ₃.

(1) At Point N, x₁ (N) and y₁ (N) are known, for the cutting edge 1, the rotating angle φ₃ of the center o₃ of the cutter head is

$${ϕ}_{3} = {tg}^{- 1} ( \frac{{a}_{t} - {x}_{1} ( N )}{{y}_{1} ( N )} ) - ( {90}^{°} - {α}_{at} ) \qquad ( 7 )$$

(2) At Point S, x₁ (S) and y₁ (S) are known, for the cutting edge 1, the rotating angle φ₃ of the center o₃ of the cutter head is

$${ϕ}_{3} = {tg}^{- 1} ( \frac{{a}_{t} - {x}_{1} ( S )}{{y}_{1} ( S )} ) + ( {90}^{°} + {α}_{at} ) \qquad ( 8 )$$

The above equations (7) and (8) establish the spatial motion relationship of the workpiece and the cutter head. The cutting edge 1 comes into cutting at point N and secedes from cutting at point S. According to the same reason, the cutting rotating angles φ₃ of the cutting edges 1, 2 and 3 can be found.

In FIG. 8(1) EN is the intersected line of the right tooth flank of the imaginary gear and the main basic circle in the main plane. Assumed that EN is considered the cutting edge, when the workpiece rotates around j₁ (o₁)-axis (i.e. Y-axis of the machine tool) for an angle φ₁, the cutter edge EN rotates around k₂ (o₂)-axis of the imaginary gear (i.e. rotates around o₂) for angle φ₂ per unit time. Lets gear ratio

$${i}_{t} = \frac{{ϕ}_{1}}{{ϕ}_{2}} ,$$

the plane enveloping motion between the imaginary gear and the worm can be realized. This invention connects the rotating cutter head with the coordinate system Σ₃ and makes the workpiece rotate around j₁ (o₁) for angle φ₁, the cutter head rotate around its own center o₃ for angle φ₃, at the same time o₃ rotate around the center o₂ of the imaginary gear for an angle τ. The cutter edge EN passes through point N, N is the end point of circular arc at the tooth tip of the worm. Each cutting edge comes into cutting at point N and secedes from cutting at point S. The motion of the machine tool can compound the five-axis simultaneous working forming motion for cutting the threads of the worm by using the cutter edge 1 to substitute for EN through controlling the rotating angle φ₁ of the workpiece, the rotating angle φ₂ of the imaginary gear and the rotating angle φ₃ of the cutter head around its own axis as well as the rotating angle τ of the cutter head around o₂. FIGS. 8(2) and 8(3) shows the motion state of the cutting edge EN under the condition of that the cutter head makes up/down shift along \overline{o₂o₅} for the distance h (h<0 or h>0).

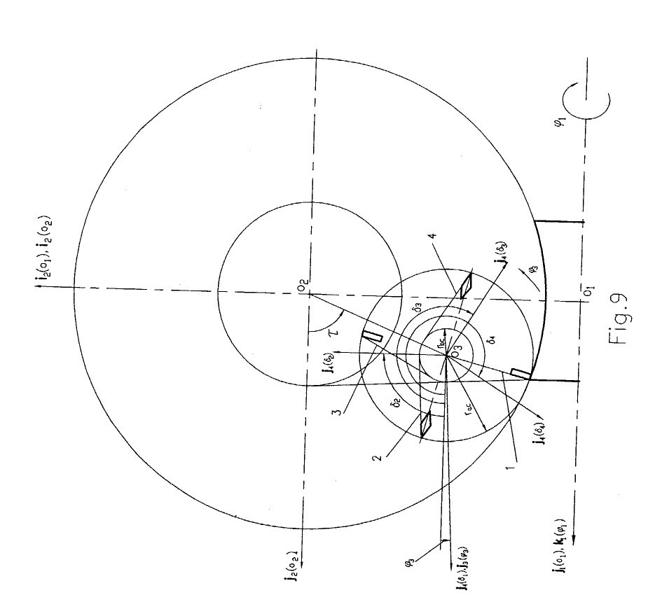

FIG. 9 shows the positions of the cutting edges of four blades on the cutter head. The cutting edges 2 and 4 are two blades for cutting the flanks of the thread. The more blades are, the higher the cutting productivity is. The fourth coordinate system Σ4:{o₃;i₄(δ), j₄(δ), k₄(δ)} is related to the cutting edges, where o₃ is congruent to o4 (i.e. o₃ is 0₄). The cutting edges 1 and 3 are used for cutting the tooth depth.

Based upon the motion principle of the existing CNC-controlled toroidal worm grinding machines, the invention can once form the tooth hank of plane enveloping toroidal worms by using above embodiments in accordance with the invention, and makes the tooth profile of the machined toroidal worms identical with that of the ground worms by toroidal worm grinding machines as mentioned above in the Patent No. ZL 92204765.0. In this case, it can greatly improve the productivity, If grinding a worm, it will take one hour from fine blank to finish formed step, while cutting a worm, it will take 10 minutes only from fine blank to formed step. If combined with the invention, it will greatly raise the productivity by taking tooth-cutting as the rough machining of the warms and then using finish grinding for improving the surface roughness of the worms. Under the condition of high-speed cutting, the rotating speed of cutter shaft and workpiece shaft can make the cutting velocity up to 200 m/min, thus the working efficiency is six to seven times higher than that of worm grinding. The machine tool of this invention is to overcome the deficiency of toroidal worm grinding machines and to provide a high-productivity tooth cutting machine tools.

Although preferred embodiments of the invention have been described above, this invention is not limited to the particular structures and features described in detail herein. It will be apparent to those skilled in the art that numerous modifications form part of the invention insofar as they do not depart from the scope of the appended claims.

1. A five-simultaneously-working-axis computerized numerical control tooth cutting machine tool for toroidal worms, including: a body of the machine tool and a controlling cabinet, the body includes: a bed, a spindle box with a spindle, a longitudinal sliding table, a traverse slider, a vertical guideway mounted on the slider, and a tailstock, a cutter rest that supports a rotating cutter head is mounted on the vertical guideway, the spindle rotates about A-axis thereof, the table longitudinally slides along Y-axis relative to the bed, the cutter head rotates about B-axis thereof and traversely shifts along X-axis, as well as the cutter head makes up/down shift along Z-axis of the guideway vertically, the control cabinet is equipped with programs for controlling the five axis of A, Y, X, Z and B simultaneously work together, wherein a first coordinate system Σ₁ is connected with the workpiece, a second coordinate system Σ₂ is connected with an imaginary gear, a third coordinate system Σ₃ is connected with the rotating cutter head and a fourth coordinate system Σ₄ is connected with the cutting edges, based upon the transformation of coordinate systems, the motion equations of five axes of A-, B-, Y-, X-, and Z-axes of the machine tool can be determined such that the shifting of cutting edge of the cutter on the cutter head is controlled to simulate an inclined plane in spatial locations in order to envelop out the tooth flank of plane enveloping toroidal worms.

2. According to the tooth cutting machine tool as mentioned in claim 1, wherein the inclined plane simulated by the cutting edge of the cutters rotates around central axis of the imaginary gear K₂ (o₂), i.e. the composition of both the rotation of B-axis and the revolution of B-axis around the axis of K₂ (o₂), at the same time workpiece rotates around K₁ (o₁) (i.e. A-axis), in the course of relative motions the tooth flank of plane enveloping toroidal worm is generated.

3. According to the tooth cutting machine tool as mentioned in claim 1 or claim 2, wherein the thread forming motion of plane enveloping toroidal worm can correctly be controlled by means of the control of the values of a rotating angle per unit time of the workpiece φ₁, a rotating angle per unit time of the imaginary gear φ₂, a rotating angle per unit time of the cutter head φ₃, an angle τ of the center o₃ of the cutter head rotating around the center o₂ of the imaginary gear and a distance h of the center o₂ of the imaginary gear making straight-line shift along the central axis thereof k₂(o₂), in which φ₁/φ₂ is equal to the gear ratio.

4. According to the tooth cutting machine tool as mentioned in claim 1, wherein there are at least two blades mounted on the rotating cutter head, the cutting edge of the blade is straight line which lies on the plane perpendicular to the axis of the rotating cutter body.

5. According to the tooth cutting machine tool as mentioned in claim 2 or 4, wherein the center o₃ of the rotating cutter head and the cutting edges are all located on two tooth planes of the imaginary gear; while two tooth planes are inclined with angle β and tangential to two imaginary spatial cones respectively, the half conic angles of two cones is equal to the inclined angle β, the diameter r_{b} of an imaginary cones is equal to the diameter r_{bt} of main basic circle of the imaginary gear, the cutting edges on the cutter head shift along the tooth plane of the imaginary gear; while the inclined plane is tangential to the spatial cone and rotates around the central axis k₂ (o₂) of the cone; the center o₂ of the imaginary gear makes up/down shifts along the vertical axis k₂ (φ₂), the cutting edge comes into cutting at point N and secedes from cutting at point S, the coordinates of every point on the workpiece makes following up motions along X-, Y- and Z-axis while makes the circular interpolating motion about B-axis.

6. According to the tooth cutting machine tool as mentioned in claim 3, wherein in accordance with the center distance aₜ between the imaginary gear and the workpiece, the coordinates of the radius vector r from the center o2 of the imaginary gear to the rotating center of the cutter head, polar angle τ and the values of the pressure angles αₐₜ, α_{ac} at the tip circle of the imaginary gear and the cutter head as well as the given coordinates x₁, y₁, z₁ of the workpiece, the motion coordinates of the rotating center o₃ of the cutter head can be found, thus the value of φ₃ can be calculated according to the following formulae when the values of x₁, y₁, z₁ at point N and point S of the machined workpiece are given, in which the cutting edge comes into cutting at point N and secedes from cutting at point S
$${ϕ}_{3 N} = {tg}^{- 1} ( \frac{{a}_{t} - {x}_{1} ( N )}{{y}_{1} ( N )} ) - ( {90}^{°} - {α}_{at} )$$
$${ϕ}_{3 S} = {tg}^{- 1} ( \frac{{a}_{t} - {x}_{1} ( S )}{{y}_{1} ( S )} ) + ( {90}^{°} + {α}_{at} )$$

7. According to the tooth cutting machine tool as mentioned in claim 6, wherein the center o₃ of the rotating cutter head, rotating around the center o₂ of the imaginary gear, makes spatial motion and cuts the thread of tooth flanks of the worm, the coordinate equations for the center o₃ of the rotating cutter head, representing in coordinate system Σ₁ are given as below:
$$\begin{matrix}{x}_{1} ( {o}_{3} ) = {α}_{t} - r sin τ \\ {y}_{1} ( {o}_{3} ) = r cos τ \\ {z}_{1} ( {o}_{3} ) = h\end{matrix} ] \qquad ( 1 )$$
Where, x₁(o₃), y₁(o₃), z₁(o₃) represent the coordinates of the center o₃ of the cutter head;
αₜ—The center distance between the imaginary gear and workpiece;
r—The coordinate value of the radius vector from the center o₃ of the cutter head to the center o₂ (o₅) of the imaginary gear;
h—The distance of vertical shift from the center o₂ of the imaginary gear to o₅. The value would be h=0, h>0 and h<0.
$$r = \sqrt{{r}_{at}^{2} + {r}_{ac}^{2} - 2 {r}_{at} {r}_{ac} cos ( {α}_{at} - {α}_{ac} )} \qquad ( 2 )$$
τ=φ₃+90°−αₐₜ−η(3)
the pressure angle at the tip circle of the imaginary gear
$${α}_{at} = {sin}^{- 1} ( \frac{{r}_{bt}}{{r}_{at}} ) \qquad ( 4 )$$
the pressure angle at the tip circle of the rotating cutter head
$${α}_{ac} = {sin}^{- 1} ( \frac{{r}_{bc}}{{r}_{ac}} ) \qquad ( 5 )$$
$$η = {sin}^{- 1} ( \frac{sin ( {α}_{at} - {α}_{ac} ) \times {r}_{ac}}{r} ) \qquad ( 6 )$$

8. According to the tooth cutting machine tool as mentioned in claim 1, wherein the spindle box and tailstock are mounted on the bed, the longitudinal sliding table is movable mounted on bed and the traverse slider is mounted on the sliding table.

9. According to the tooth cutting machine tool as mentioned in claim 1, wherein the longitudinal sliding table is movable mounted on bed, and the spindle and tailstock are fixed on sliding table, the traverse slider is mounted on bed.
